(19) United States
(12) Patent Application Publication
(10) Pub. No.: US 2025/0037172 A1
(43) Pub. Date: Jan. 30, 2025

(54) DELIVERY INFORMATION PROVISION SERVER INCLUDING CONTROLLER CONFIGURED TO DETERMINE SPECIFIC PIECE OF DELIVERY INFORMATION AND TRANSMIT THE SAME TO PRINTER

(71) Applicant: BROTHER KOGYO KABUSHIKI KAISHA, Nagoya (JP)

(72) Inventor: Tetsuya OKUNO, Nagoya (JP)

(21) Appl. No.: 18/773,789

(22) Filed: Jul. 16, 2024

(30) Foreign Application Priority Data
Jul. 27, 2023 (JP) 2023-122333

(51) Int. Cl. G06Q 30/0273; G06F 3/12

(52) U.S. Cl. CPC G06Q 30/0275; G06F 3/1259

(57) ABSTRACT

A delivery information provision server includes a controller configured to perform: transmitting a bid solicitation request to a delivery information management server requesting to hold an auction in which bids are solicited for use of an information delivery service; determining, from among one or more pieces of delivery information corresponding to one or more bids placed in the auction and received from the delivery information management server, specific piece of delivery information corresponding to a winning bid among the one or more bids; transmitting the determined specific piece of delivery information to a printer; determining whether a predetermined condition corresponding to completion of printing of the specific piece of delivery information has been met; and transmitting, when determining that the predetermined condition has been met, winning bid rescission information to the delivery information management server indicating that the winning bid has been rescinded.

### REFERENCE TO RELATED APPLICATIONS

This application claims priority from Japanese Patent Application No. 2023-122333 filed on Jul. 27, 2023. The entire content of the priority application is incorporated herein by reference.

### BACKGROUND ART

There has been conventionally known a system including a print job delivery server that transmits a print job to an image forming apparatus specified in a delivery request received from a terminal device. When determining that printing for the print job has been completed, the print job delivery server charges a user of the terminal device delivery costs.

### SUMMARY

One conceivable use of the conventional system is to solicit bids for delivery information, such as advertisements, set those bids that satisfy certain conditions as winning bids, and deliver delivery information corresponding to the winning bids to a printer so that the printer can perform printing of the delivery information. However, the conventional system does not consider what actions should be taken for the winning bidders when the printer fails to print delivery information of the winning bidders.

In view of the foregoing, it is an object of the present disclosure to provide a delivery information provision server capable of performing a suitable process for bidders of delivery information when a printer fails to print delivery information of the bidders.

In order to attain the above and other objects, according to one aspect, the present disclosure provides a delivery information provision server including a controller. The controller is configured to perform: (a) transmitting a bid solicitation request to a delivery information management server, the bid solicitation request requesting the delivery information management server to hold an auction in which bids are solicited for use of an information delivery service; (b) receiving, from the delivery information management server, one or more pieces of delivery information corresponding to one or more bids placed in the auction held in response to the bid solicitation request, each of the one or more pieces of delivery information being information designated as a target of the information delivery service by the corresponding bid; (c) determining, after receiving the one or more pieces of delivery information, specific piece of delivery information from among the one or more pieces of delivery information received from the delivery information management server, the specific piece of delivery information corresponding to a winning bid among the one or more bids placed in the auction; (d) transmitting, in response to determining the specific piece of delivery information, a delivery decision notice to the delivery information management server, the delivery decision notice being a notice of a decision to deliver the specific piece of delivery information to a printer as the information delivery service; (e) transmitting the specific piece of delivery information to the printer; (f) executing a waiting process to wait for progress information from the printer, the progress information indicating progress of printing of the specific piece of delivery information by the printer; (g) determining whether or not results of the waiting process meet a predetermined condition, the predetermined condition corresponding to completion of the printing of the specific piece of delivery information; and (h) transmitting, when determining that the results of the waiting process do not meet the predetermined condition, winning bid rescission information to the delivery information management server, the winning bid rescission information indicating that the winning bid has been rescinded.

In the above structure, the controller executes the waiting process in the (f) executing to wait for progress notification, and determines in the (g) determining whether results of the waiting process meet a predetermined condition. When determining that the results of the waiting process do not meet the predetermined condition, the controller transmits winning bid rescission information to the delivery information management server in the (h) transmitting, and the winning bid is rescinded.

According to the above process, when delivery of the specific piece of delivery information has failed or printing of the specific piece of delivery information by the printer has failed, the controller determines that the predetermined condition is not met, thereby rescinding the winning bid corresponding to the specific piece of delivery information. Particularly, this process can avoid charging a delivery cost when the delivery or the printing of the specific piece of delivery information has failed. Accordingly, the controller can perform an appropriate process for the winning bidder who has submitted the specific piece of delivery information. Since the winning bidder can avoid processing delays related to the delivery cost and the like, which could be caused by the specific piece of delivery information not being printed for some reason or being printed later than expected, the winning bidder can perform proper budget management.

According to another aspect, the present disclosure also provides a delivery information provision server including a controller. The controller is configured to perform: (a) transmitting a bid solicitation request to a delivery information management server, the bid solicitation request requesting the delivery information management server to hold an auction in which bids are solicited for use of an information delivery service; (b) receiving, from the delivery information management server, one or more pieces of delivery information corresponding to one or more bids placed in the auction held in response to the bid solicitation request, each of the one or more pieces of delivery information being information designated as a target of the information delivery service by the corresponding bid; (c) determining, after receiving the one or more pieces of delivery information, specific piece of delivery information from among the one or more pieces of delivery information received from the delivery information management server, the specific piece of delivery information corresponding to a winning bid among the one or more bids placed in the auction; (d) transmitting, in response to determining the specific piece of delivery information, a delivery decision notice to the delivery information management server, the delivery decision notice being a notice of a decision to deliver the specific piece of delivery information to a printer as the information delivery service; (e) setting a time limit within which a cost for delivering the specific piece of delivery information is to be charged; (f) transmitting the specific piece of delivery information to the printer; (g) executing a waiting process to wait for progress information from the printer, the progress information indicating progress of printing of the specific piece of delivery information by the printer; and (h) transmitting, when receiving, within the time limit in the waiting process, the progress information indicating that the printing of the specific piece of delivery information has been completed, a billing notice to the delivery information management server, the billing notice being a notice for charging the cost for delivering the specific piece of delivery information.

In the above structure, the controller sets a time limit within which charging of a delivery cost is to be performed in the (e) setting. When receiving within the time limit in the waiting process the progress information indicating that the printing of the specific piece of delivery information has been completed, the controller transmits a billing notice to the delivery information management server in the (h) transmitting.

According to the above process, the controller transmits a billing notice for charging a cost for delivering the specific piece of delivery information only when printing of the specific piece of delivery information has been completed properly within the time limit. Accordingly, the winning bidder who has submitted the specific piece of delivery information can quickly learn when the specific piece of delivery information has not been printed within the time limit, thereby facilitating budget management for the winning bidder.

### BRIEF DESCRIPTION OF DRAWINGS

FIG. 1 is a block diagram illustrating one example of the overall configuration of an information delivery system.

FIG. 2 is a sequence chart illustrating one example of steps in processes executed by an advertisement provision server, an advertisement management server, a terminal device, and a printer in cooperation with each other.

FIG. 3 is the sequence chart subsequent to FIG. 2 illustrating the one example of the steps in the processes executed by the advertisement provision server, the advertisement management server, the terminal device, and the printer in cooperation with each other.

### DESCRIPTION

Hereinafter, one embodiment of the present disclosure will be described while referring to the accompanying drawings. In the present embodiment, the present disclosure is applied to an information delivery system that delivers advertisement information from a server to printers for printing.

### <Overall Configuration of Information Delivery System>

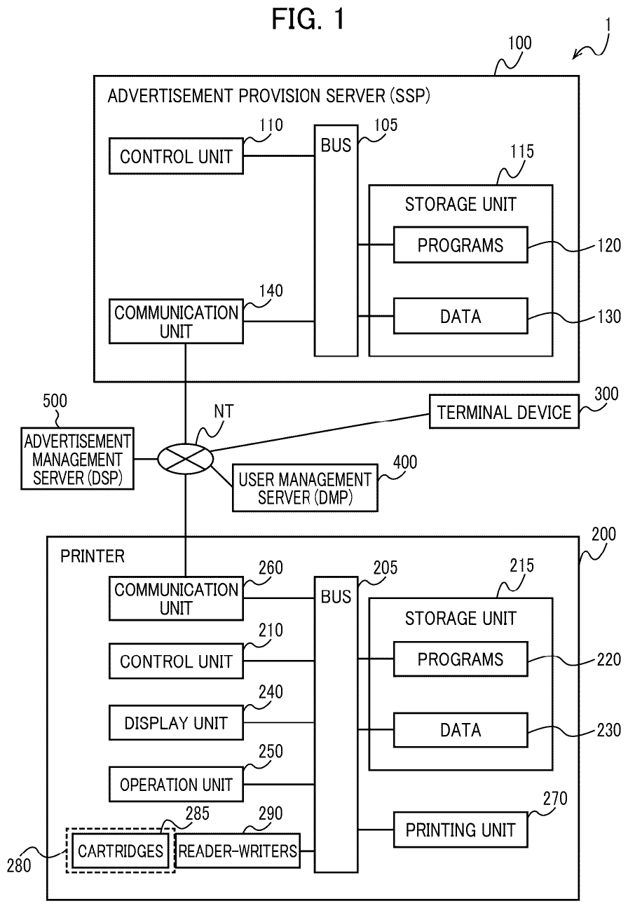

FIG. 1 illustrates one example of the overall configuration of an information delivery system 1 according to the present embodiment. As illustrated in FIG. 1, the information delivery system 1 includes an advertisement provision server (SSP: a supply-side platform) 100, a printer 200, a terminal device 300, a user management server (DMP: a data management platform) 400, and an advertisement management server (DSP: a demand-side platform) 500.

The servers 100, 400, and 500, the printer 200, and the terminal device 300 each include a communication unit and can communicate with each other over a network NT. The network NT includes at least one of the Internet, a local area network (LAN), and a wide area network (WAN). The communication units may include a plurality of types of communication circuits for connecting to the network NT. In this case, each device connected to the network NT may communicate with a plurality of other devices using different communication circuits. In the present embodiment, the different types of communication circuits are collectively referred to as “communication unit”.

### <Terminal Device>

The terminal device 300 is a smartphone or other portable device owned by a user, for example. In this example, the terminal device 300 is connected to the network NT via a wireless communication. In place of a smartphone, the terminal device 300 may be any suitable terminal other than the printer 200, such as a tablet computer, a laptop computer, a desktop computer, or the like. Alternatively, the terminal device 300 may be a portable or stationary terminal provided in a karaoke box, any of various types of stores, and the like for selecting songs, selecting items from menus, or browsing products, for example.

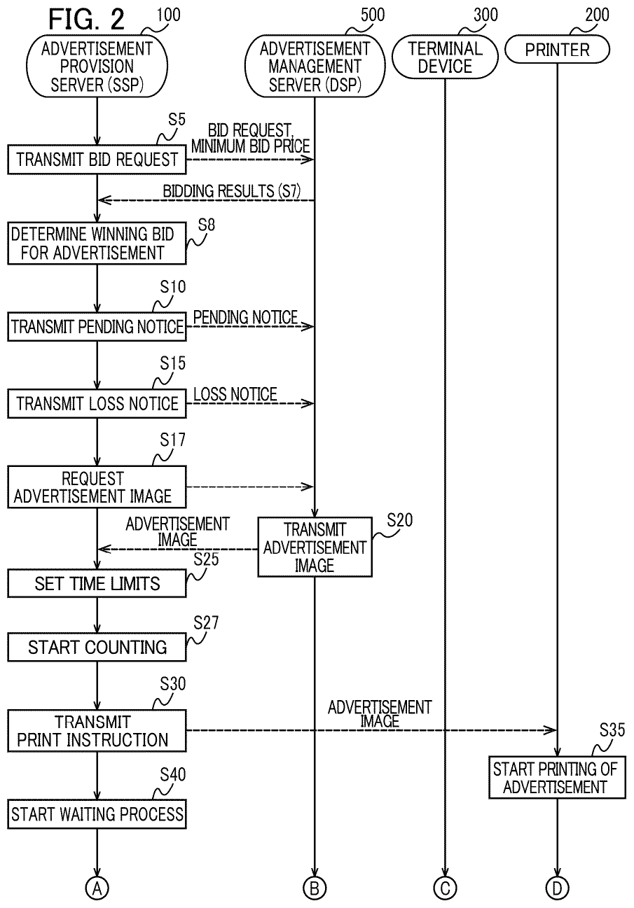

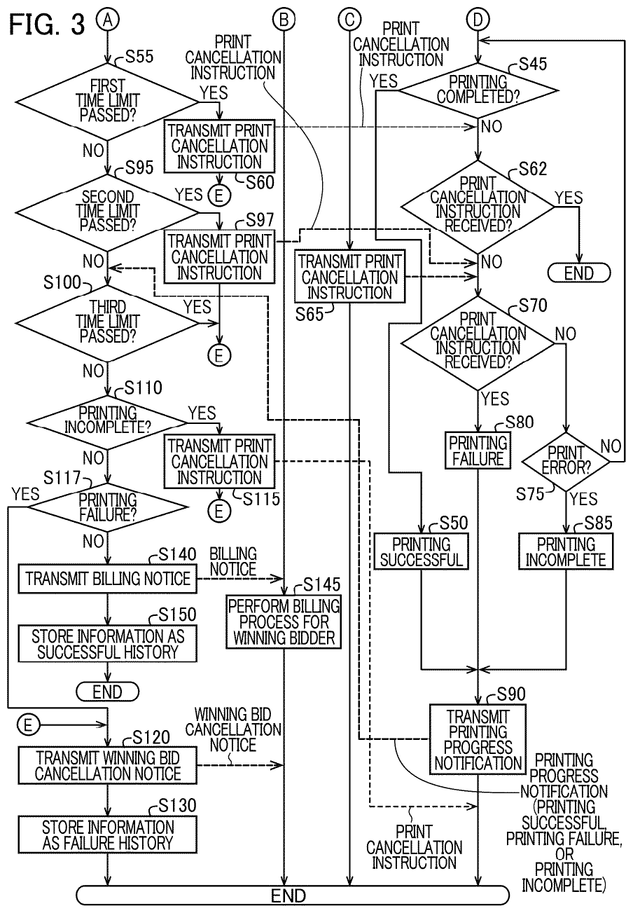

Although not illustrated in the drawings, the terminal device 300 includes a display unit, a control unit, an operation unit, a storage unit, a communication unit, and the like. The storage unit stores therein various programs. The control unit is configured to execute the various programs stored in the storage unit. These programs include a program for implementing the process illustrated in the flowchart in FIGS. 2 and 3 (described later). By operating the operation unit, the user can input various instructions into the terminal device 300.

### <User Management Server>

The user management server 400 is configured to manage information on the user via the terminal device 300. Although not illustrated in the drawings, the user management server 400 includes a control unit, a storage unit, a communication unit, and the like.

### <Advertisement Provision Server>

The advertisement provision server 100 is a server that is installed and managed by the manufacturer of the printer 200, for example. At predetermined timings, the advertisement provision server 100 receives advertisement images from the advertisement management server 500. The advertisement provision server 100 then delivers the received advertisement images to the printer 200 for printing. The advertisement provision server 100 is an example of the “delivery information provision server” of the present disclosure. The advertisement image is an example of the “one or more pieces of delivery information” of the present disclosure.

More specifically, the advertisement provision server 100 includes a control unit 110, a storage unit 115, and a communication unit 140. The control unit 110, the storage unit 115, the communication unit 140, and the like are connected to each other via a bus 105 and can exchange information with each other. The storage unit 115 is configured of RAM, ROM, EEPROM, a hard disk drive, and the like, for example. The storage unit 115 stores therein various programs 120, and various data 130. The programs 120 include an information delivery program for controlling the advertisement provision server 100 to implement a control process according to the flowchart in FIGS. 2 and 3 (described later). The data 130 includes a printer ID for the printer 200, a user ID of the user, advertisement images, and the like. The control unit 110 is an example of the “controller” of the present disclosure.

The control unit 110 is a device, such as a CPU or other processor, that performs data processing. The control unit 110 is configured to execute the various programs 120 stored in the storage unit 115. The control unit 110 is configured to implement various processes including data communications with the printer 200, the terminal device 300, the user management server 400, and the advertisement management server 500 which are connected to the network NT. The communication unit 140 includes such hardware as a network interface card (NIC) for connecting to Ethernet. The communication unit 140 is connected to the network NT and is configured to communicate with the printer 200, the terminal device 300, the user management server 400, and the advertisement management server 500.

### <Advertisement Management Server>

The advertisement management server 500 is configured to transmit advertisement images to be printed by the printer 200 to the advertisement provision server 100. Although not illustrated in the drawings, the advertisement management server 500 includes a control unit, a storage unit, a communication unit, and the like. In this example, the advertisement management server 500 is configured to receive a bid request from the advertisement provision server 100 via the communication unit.

The terminal devices or servers (not illustrated) of a plurality of advertisers are connected to the network NT. The control unit of the advertisement management server 500 is configured to hold an auction in response to the above bid request to solicit bids and advertisement images from the advertisers and to obtain suitable advertisement images through bids from the participating advertisers. Specifically, when there is a winning bid that meets predetermined conditions of the auction, the control unit of the advertisement management server 500 acquires the corresponding advertisement image from the terminal device or the like of the advertiser who is the winning bidder. After acquiring the advertisement image, the advertisement management server 500 transmits this advertisement image to the advertisement provision server 100 via the communication unit, the advertisement provision server 100 transfers the advertisement image to the printer 200, and the printer 200 prints the advertisement image.

Note that the advertisement provision server 100 may be configured to acquire the above advertisement image from the advertisement management server 500, or the advertisement management server 500 may acquire the advertisement image from another external server and may transmit the acquired advertisement image to the advertisement provision server 100. The advertisement management server 500 is an example of the “delivery information management server” of the present disclosure.

Note that the servers 100, 400, and 500 may each be configured as a standalone server or may each be configured of a cluster of multiple servers. Alternatively, a single standalone server may be provided with the functions of two or more of the servers 100, 400, and 500.

### <Printer>

The printer 200 is assigned the printer ID described above. The printer 200 includes a control unit 210, a storage unit 215, a display unit 240, an operation unit 250, a communication unit 260, and a printing unit 270. The control unit 210, the storage unit 215, the display unit 240, the operation unit 250, the communication unit 260, and the printing unit 270 are connected to each other via a bus 205 and can exchange information with each other.

The storage unit 215 is configured of RAM, ROM, EEPROM, and a hard disk drive, for example. The storage unit 215 stores therein various programs 220, and various data 230. The programs 220 include a program for controlling the printer 200 to perform a control process according to the process in the flowchart of FIGS. 2 and 3 (described later), for example. The data 230 includes the printer ID described above, and advertisement images received from the advertisement provision server 100, and specifically advertisement images acquired from the terminal devices or the like of winning bidders among advertisers participating in auctions and relayed by the advertisement provision server 100.

Note that at least some of the various data described above may be stored in the storage unit 115 of the advertisement provision server 100. Alternatively, at least some of the data, which is original data, may be stored in one of the storage unit 215 of the printer 200 and the storage unit 115 of the advertisement provision server 100, and duplicate data of this original data may be stored in the other of the storage unit 215 of the printer 200 and the storage unit 115 of the advertisement provision server 100.

The control unit 210 is a device, such as a CPU or other processor, that performs data processing. The control unit 210 is configured to execute the various programs 220 stored in the storage unit 215. The display unit 240 is a liquid crystal display, for example, that can display thereon various information. The operation unit 250 is configured of a keyboard and buttons, for example, and is configured to receive input operations from the user. By operating the operation unit 250, the user can input various instructions into the printer 200. The communication unit 260 is connected to the network NT and is configured to communicate with the advertisement provision server 100, the advertisement management server 500, the user management server 400, and the terminal device 300. The printing unit 270 includes a printing engine. The printing unit 270 is configured to print an image on sheets of printing paper by forming images on the sheets according to the inkjet method while feeding and conveying the sheets from a paper tray with a conveying mechanism (not illustrated), for example.

The printer 200 also includes a cartridge holder 280. The cartridge holder 280 can accommodate therein a plurality of cartridges 285. The cartridges 285 include cartridges for a plurality of ink colors, including cyan, magenta, yellow, and black, for example. The cartridge holder 280 includes ink level sensors (not illustrated) that can detect the residual quantities or the consumed quantities of ink in the respective cartridges 285 for the plurality of ink colors according to a known method.

The printing unit 270 performs printing processes while consuming ink from the cartridges 285. The cartridge holder 280 also includes reader-writers 290. Each of the reader-writers 290 reads cartridge information from and writes cartridge information to an IC chip provided on the corresponding cartridge 285 accommodated in the cartridge holder 280. Each of the reader-writers 290 detects the type and the like of the corresponding cartridge 285 accommodated in the cartridge holder 280 by reading cartridge information from the IC chip of the corresponding cartridge 285, for example. Each of the reader-writers 290 may also detect the consumed quantity or the residual quantity of ink in the corresponding cartridge 285 by reading the IC chip of the corresponding cartridge 285.

### Features of the Embodiment

As described above, the advertisement management server 500 in the present embodiment holds an auction to solicit bids for advertisements. When there is a winning bid among the submitted bids that satisfies certain conditions, the advertisement provision server 100 delivers the advertisement image of the winning bidder to the printer 200 so that the advertisement image is printed by the printer 20.

However, there are some cases in which the printer 200 fails to print the advertisement of the winning bidder due to some unforeseen circumstances. The feature of the present embodiment is that, in the event of a failure to print an advertisement, any disadvantage to the winning bidder can be avoided by rescinding the winning bid described above. The process will be described below in detail with reference to FIGS. 2 and 3. FIGS. 2 and 3 are sequence flows illustrating a control process executed by the advertisement provision server 100, the advertisement management server 500, the printer 200, and the terminal device 300 in cooperation with each other.

In S5 of FIG. 2, the advertisement provision server 100 first determines a minimum bid price for soliciting bids for delivery of advertisement images. The minimum bid price is uniquely determined in advance and stored in the storage unit 115, for example. In S5 the advertisement provision server 100 determines a minimum bid price on the basis of the contents stored in the storage unit 115, and transmits a bid request including the minimum bid price to the advertisement management server 500. The process executed in S5 is an example of the “(a) transmitting” of the present disclosure. The bid request is an example of the “bid solicitation request” of the present disclosure.

In response to the bid request transmitted from the advertisement provision server 100, the advertisement management server 500 holds an auction in which bids are solicited for delivery of suitable advertisements (i.e., for use of an information delivery service provided by the information delivery system 1). When soliciting bids, the advertisement management server 500 requests advertisement images that satisfy predetermined conditions including that the bid price be higher than or equal to the minimum bid price.

In S7 the advertisement provision server 100 receives bidding results from the advertisement management server 500 for the auction held in response to the bid request transmitted in S5. When a bid that satisfies the predetermined conditions requested by the bid request has been placed, the content of the received bidding results includes the advertisement image corresponding to the bid that satisfies the predetermined conditions. Specifically, the advertisement image included in the content of the bidding results is information designated as a target of the information delivery service in association with placement of the corresponding bid that satisfies the predetermined conditions. On the other hand, when no bids that satisfy the predetermined conditions requested by the bid request have been placed, such information is included in the content of the bidding results. The process executed in S7 is an example of the “(b) receiving” of the present disclosure.

In S8 the advertisement provision server 100 determines, on the basis of the content received in S7, whether a bid that satisfies winning bid conditions has been placed. A bid that satisfies the winning bid conditions is determined as a winning bid for the advertisement. The winning bid conditions include a condition that the bid price is the highest, for example. The winning bid conditions may include other conditions that the predetermined conditions requested by the bid request are satisfied. The advertisement image corresponding to the bid that satisfies the winning bid conditions is an example of the “specific piece of delivery information” of the present disclosure. The process executed in S8 is an example of the “(c) determining” of the present disclosure.

In S10 the advertisement provision server 100 transmits a pending notice to the advertisement management server 500 in order to notify the winning bidder, i.e., the advertiser who has submitted the bid that satisfies the winning bid conditions, that the content of the bid will be stored for use without deletion. That is, the pending notice is a notice of a decision to transmit the advertisement image of the winning bidder to the printer 200. Upon receiving the pending notice, the advertisement management server 500 transfers the pending notice to the terminal device or the like of the winning bidder. The pending notice is an example of the “delivery decision notice” of the present disclosure. The process executed in S10 is an example of the “(d) transmitting” of the present disclosure.

In S15 the control unit 110 transmits a loss notice to the advertisement management server 500 in order to notify unsuccessful bidders, i.e., advertisers who have submitted bids that does not satisfy the winning bid conditions, that their contents of the bids will not be adopted because another bidder had the winning bid. Upon receiving the loss notice, the advertisement management server 500 transfers the loss notice to the terminal devices or the like of the unsuccessful bidders. Note that a plurality of loss notices may be transmitted when a plurality of bids does not satisfy the winning bid conditions.

In S17 the advertisement provision server 100 transmits an advertisement image request to the advertisement management server 500 requesting the advertisement image of the winning bidder to which a pending notice has been transmitted in S10. When there is a plurality of winning bidders, the advertisement provision server 100 may request a plurality of advertisement images. In response to receiving the advertisement image request, in S20 the advertisement management server 500 transmits the advertisement image of the winning bidder to the advertisement provision server 100. The advertisement provision server 100 receives the advertisement image and stores the received advertisement image in the storage unit 115, for example.

In S25 the advertisement provision server 100 sets time limits, which are criteria for success or failure of printing on the printer 200 described above. Three types of time limits are set in the present embodiment. The process executed in S25 is an example of the “(e) setting” of the present disclosure.

The first of the time limits is a first time limit for the advertisement provision server 100 which is a predetermined time limit for charging the advertisement management server 500 delivery costs. In other words, when the advertisement image delivered to the printer 200 has been printed, the advertisement provision server 100 bills the winning bidder the cost for printing the advertisement (refer to the process in S140 described later). In the present embodiment, the first time limit in S25 can be set as a time allowed for performing a successful printing on the printer 200 and transmitting an invoice for the costs. As an example, the first time limit may be within ten minutes from the point that the advertisement provision server 100 starts a time counter in S27 described later. The first time limit may be stored in the storage unit 115 in advance, or set on the basis of instructions from the advertisement management server 500.

The other time limits are a second time limit and a third time limit that are predetermined tine limits within which printing of advertisements is to be completed. In other words, the advertiser may have strict time demands in cases where the value of their advertisement would drop significantly if printing has not been completed within a certain period of time, as in advertisements for selling fresh foods, for example. Accordingly, the present embodiment allows the second time limit and the third time limit to be set as time limits for completing the printing of advertisements on the printer 200. The distinction in processing with the second time limit and the third time limit will be described below.

The second time limit and the third time limit may be set on the basis of a remaining time, such as a time within 24 hours from the start of counting in S27 described later, or may be set according to an ending time such as by 10:00 a.m. The second time limit and the third time limit may be stored in the storage unit 115 in advance or set on the basis of instructions from the advertisement management server 500. These time limits may also be attached to the advertisement images transmitted by the advertisement management server 500 in S20. Further, the second time limit and the third time limit may be the same time, or the third time limit may be longer (later) than the second time limit. The first time limit is an example of the “time limit” of the present disclosure, and the third time limit is an example of the “another time limit” of the present disclosure.

The advertisement provision server 100 may set all of the first to third time limits in S25, or may set only one or two of the first to third time limits.

In S27 the advertisement provision server 100 starts a time counter for the time limits set in S25.

In S30 the advertisement provision server 100 generates a delivery image. The advertisement image of the winning bidder, specifically, information including the advertisement image received from the advertisement management server 500 in S20 is arranged in the delivery image. Although the advertisement provision server 100 generates the delivery image in S30, the advertisement management server 500 may generate the delivery image instead, and the advertisement provision server 100 may acquire the delivery image from the advertisement management server 500. Further, rather than generating a delivery image in S30, the advertisement provision server 100 may generate print data for printing a delivery image in any of various page description languages.

The advertisement provision server 100 delivers the print instruction including the generated delivery image to the printer 200. The print instruction may also include a command for the printer 200 to cancel the printing process when a print cancellation instruction is inputted in S60, S97, S115, or the like described later or when a print error occurs in S75 described later. The process executed in S30 is an example of the “(e) transmitting” and the “(f) transmitting” of the present disclosure.

In S35 the printer 200 receives the print instruction from the advertisement provision server 100 transmitted in S30 and stores the received print instruction in the storage unit 215. Subsequently, the printer 200 starts to print the delivery image included in the print instruction. Note that the advertisement provision server 100 may deliver the delivery image to the printer 200 through a relay device in S30. Alternatively, instead of delivering the delivery image to the printer 200, the advertisement provision server 100 may transmit a page description language required for printing the delivery image or a link to the delivery image to the printer 200. In a case where the advertisement provision server 100 transmits a link to the delivery image to the printer 200, the printer 200 receives the link and accesses the link to acquire the delivery image and perform printing.

After transmitting the print instruction in S30, in S40 the advertisement provision server 100 starts a waiting process to wait for a printing progress notification described later. The printing progress notification is an example of the “progress information” of the present disclosure. The process executed in S40 is an example of the “(f) executing” and the “(g) executing” of the present disclosure.

In S45 of FIG. 3, the printer 200 determines whether or not printing of the delivery image containing the advertisement image started in S35 has been completed. When the printer 200 determines in S45 that printing has been completed (S45: YES), in S50 the printer 200 sets the content of the printing progress notification to be transmitted in S90 described later to “printing successful”. Subsequently, in S90 the printer 200 transmits the printing progress notification with the content “printing successful” to the advertisement provision server 100.

In the meantime, after starting the waiting process in S40, the advertisement provision server 100 determines whether or not a timeout has occurred while a printing progress notification has not yet been received. Specifically, in S55 the advertisement provision server 100 determines whether or not the first time limit set in S25 has passed on the basis of the elapsed time after timing has started in S27. When the advertisement provision server 100 determines in S55 that the first time limit has passed before the advertisement provision server 100 receives the printing progress notification transmitted by the printer 200 in S90 because printing has not yet been completed, for example (S55: YES), in S60 the advertisement provision server 100 transmits a print cancellation instruction to the printer 200. After transmitting the print cancellation instruction in S60, the advertisement provision server 100 advances to the process in S120 described later. The process executed in S60 is an example of the “(j) transmitting” of the present disclosure.

In the meantime, when determining in S45 that printing has not yet been completed (S45: NO), in S62 the printer 200 determines whether or not a print cancellation instruction has been received from the advertisement provision server 100. When the printer 200 determines in S62 that a print cancellation instruction has been received (S62: YES), the printer 200 deletes the delivery image received in S30 from the storage unit 215, and cancels the printing process. Subsequently, the process of FIG. 3 ends for the printer 200.

On the other hand, when the advertisement provision server 100 determines in S55 that the first time limit has not passed (S55: NO), in S95 the advertisement provision server 100 determines whether or not the second time limit set in S25 has arrived its deadline on the basis of the elapsed time of the timing started in S27 while a printing progress notification has not been received.

When the advertisement provision server 100 determines in S95 that the second time limit has passed before a printing progress notification transmitted from the printer 200 in S90 is received because printing has not yet been completed, for example (S95: YES), in S97 the advertisement provision server 100 transmits a print cancellation instruction to the printer 200. After transmitting the print cancellation instruction in S97, the advertisement provision server 100 advances to the process in S120 described later. The process executed in S97 is an example of the “(k) transmitting” of the present disclosure.

Note that the advertisement provision server 100 performs the determinations in S55 and S95 until a printing progress notification has been received, or the first time limit or the second time limit has passed (S55: YES or S95: YES).

Further, when the user performs an operation on the terminal device 300 to cancel printing while printing has not yet been completed, as described above, in S65 the terminal device 300 transmits a corresponding print cancellation instruction to the printer 200.

When the printer 200 determines in S62 that a print cancellation instruction has not been received in S62 (S62: NO), in S70 the printer 200 determines whether or not a print cancellation instruction transmitted in S97 or S65 described above has been received. When the printer 200 determines in S70 that a print cancellation instruction transmitted in S97 or S65 has been received (S70: YES), in S80 the printer 200 deletes the delivery image received in S30 from the storage unit 215 and cancels the printing process. The printer 200 then sets the content of the printing progress notification to “printing failure”. Note that in the case of a printing failure, the printer 200 adds information to the printing progress notification specifying the reason for the printing failure, such as information indicating that printing has not been completed by the second time limit or printing has been cancelled by the user.

When the printer 200 determines in S70 that no print cancellation instruction has been transmitted in S97 or S65 (S70: NO), in S75 the printer 200 determines whether or not a printer error has occurred. A printer error is a condition that any malfunction has occurred that makes it difficult for the printer 200 to start or continue printing due to a problem such as a paper jam, depletion of ink consumable, or the communication unit 260 becoming disconnected from the network NT, taking the printer 200 offline. When the printer 200 determines in S75 that no printer error has occurred (S75: NO), the printer 200 returns to the process in S45 and continues printing until printing is completed (S45: YES).

However, when the printer 200 determines in S75 that a printer error has occurred (S75: YES), in S85 the printer 200 sets the content of the printing progress notification to “print incomplete”. At this time, the printer 200 adds information to the printing progress notification explaining what kind of printer error causes printing to be incomplete, such as the occurrence of a paper jam.

Subsequently, in S90 the printer 200 transmits the printing progress notification representing the processing progress on the printer 200, such as “printing successful”, “printing failure”, or “print incomplete,” to the advertisement provision server 100.

On the other hand, when the advertisement provision server 100 determines in S95 that the second time limit has not passed (S95: NO), in S100 the advertisement provision server 100 determines whether or not a printing progress notification has been received from the printer 200 in S90 described above but a timeout has occurred. That is, the advertisement provision server 100 determines whether or not the third time limit set in S25 has passed on the basis of the time elapsed since timing was started in S27 while a printing progress notification has been received from the printer 200.

When the advertisement provision server 100 determines in S100 that the third time limit has arrived (S100: YES), the advertisement provision server 100 advances to the process in S120 described later. However, when the advertisement provision server 100 determines in S100 that the third time limit has not arrived (S100: NO), the advertisement provision server 100 advances to the process in S110.

In S110 the advertisement provision server 100 determines whether or not the printing progress notification transmitted from the printer 200 in S90 indicates “printing incomplete”. When the advertisement provision server 100 determines in S110 that the printing progress notification indicates “printing successful” or “printing failure” (S110: NO), the advertisement provision server 100 advances to the process in S117 described below. When the advertisement provision server 100 determines in S110 that the printing progress notification indicates “printing incomplete” (S110: YES), in S115 the advertisement provision server 100 transmits a print cancellation instruction to the printer 200. After transmitting the print cancellation instruction in S115, the advertisement provision server 100 advances to the process in S120 described later. The process executed in S115 is an example of the “(l) transmitting” of the present disclosure.

When a print cancellation instruction has been received from the advertisement provision server 100 in S115, the printer 200 deletes the delivery image received in S30 from the storage unit 215 and cancels the printing process. Subsequently, the process of FIG. 3 ends for the printer 200.

In S117 the advertisement provision server 100 determines whether or not the printing progress notification transmitted from the printer 200 in S90 indicates “printing failure”. When the advertisement provision server 100 determines in S117 that the printing progress notification indicates “printing failure” (S117: YES), the advertisement provision server 100 advances to the process in S120 described later. However, when the advertisement provision server 100 determines in S117 that the printing progress notification indicates “printing successful” (S117: NO), the advertisement provision server 100 advances to the process in S140.

The process in S55, S95, S100, S110, and S117 executed by the advertisement provision server 100 are each an example of the “(g) determining” of the present disclosure. The conditions used for determinations in the respective processes are each an example of the “predetermined condition corresponding to completion of the printing for the specific delivery information”.

In S140 the advertisement provision server 100 transmits a billing notice to the advertisement management server 500 in order that the advertisement management server 500 can bill the advertiser, i.e., the winning bidder who has provided the advertisement image included in the delivery image transmitted in S30, the corresponding costs for printing the advertisement. The process executed in S140 is an example of the “(i) transmitting” and the “(h) transmitting” of the present disclosure.

Upon receiving the billing notice from the advertisement provision server 100, in S145 the advertisement management server 500 performs a billing process to transmit the billing notice to the terminal device or the like of the winning bidder.

In S150 the advertisement provision server 100 stores the delivery image transmitted in S30 in the storage unit 115 in association with the printer ID of the corresponding printer 200, the user ID of the corresponding user, the current time information, and the winning bid conditions met by the bid corresponding the advertisement image included in the delivery image as a successful history. Subsequently, the process according to the sequence flow in FIG. 3 ends.

Following any of the processes in S60, S97, S100 (S100: YES), S115, or S117 (S117: YES), in S120 the advertisement provision server 100 transmits a winning bid cancellation notice to the advertisement management server 500 instructing the advertisement management server 500 to rescind the winning bid determined in S8. The advertisement management server 500 notifies the winning bidder, i.e., the advertiser of these advertisements that the winning bid has been cancelled. The winning bid cancellation notice is an example of the “winning bid rescission information” of the present disclosure. The process executed in S120 by the advertisement provision server 100 is an example of the “(h) transmitting” of the present disclosure.

In S130 the advertisement provision server 100 associates the delivery image for which winning bids have been cancelled in S120 with various history information such as the winning bidding conditions when bids for the advertisement image included in the delivery image has been placed, information indicating the reason for the printing failure described above, and the date and time that the printing failure has been confirmed, and stores the associated information in the storage unit 115 as a failure history. Subsequently, the advertisement provision server 100 ends the process of FIG. 3. The process executed in S130 is an example of the “(m) creating” of the present disclosure.

### Advantages of the Embodiment

In the embodiment described above, bids are solicited in an auction for delivery of advertisements to be printed on the printer 200, and advertisements are delivered to the printer 200 for printing on the basis of the bidding results. More specifically, in S5 the advertisement provision server 100 transmits a bid request to the advertisement management server 500 and in S8 determines what advertisements received from the advertisement management server 500 are advertisements of winning bidders (i.e., advertisement that satisfy the winning bid conditions).

In S10 the advertisement provision server 100 transmits a pending notice for the advertisements of the winning bidders to the advertisement management server 500 and in S30 delivers the advertisements of the winning bidders to the printer 200. In S40 the advertisement provision server 100 starts a waiting process to wait for a printing progress notification indicating the progress of processing of the advertisements by the printer 200 and, in the waiting process started in S40, determines in S55, S95, S100, S110, and S117 whether a predetermined condition is met by the results of the waiting process.

When the advertisement provision server 100 determines that a predetermined condition is not met in any of the process in S55, S95, S100, S110, or S117, in S120 the advertisement provision server 100 transmits a winning bid cancellation notice to the advertisement management server 500, whereby the winning bids are rescinded.

According to the above embodiment, when the delivery of advertisements to the printer 200 fails (S55, S95: YES) or when printing of advertisements by the printer 200 is too slow (S100: YES) or when printing is not successful (S110: YES, S117: YES), the advertisement provision server 100 determines that the predetermined condition is not met and in S120 rescinds the winning bids of the winning bidders. Particularly, the advertisement provision server 100 can avoid charging the winning bidders a delivery cost when the delivery or printing of the advertisements of the winning bidders has failed (S117: YES). As a result, the advertisement provision server 100 can perform an appropriate process for the winning bidders. The advertisers, i.e., the winning bidders can avoid processing delays related to delivery costs and the like, which could be caused by their advertisements not being printed for some reason or being printed later than expected, whereby the advertisers can perform proper budget management.

Another feature of the above embodiment is that, when the advertisement provision server 100 determines that the predetermined condition is met in all of S55, S95, S100, S110, and S117, in S140 the advertisement provision server 100 transmits a billing notice for charging delivery costs for the advertisements to the advertisement management server 500. Thus, the above embodiment can reliably charge advertisers delivery costs as usual when the delivery and printing of the advertisements of the winning bidders is completed properly and successfully.

Another feature of the above embodiment is the addition of a time limit on charging delivery costs. A first time limit for charging delivery costs is set in advance in S25. When the advertisement provision server 100 has not received a printing progress notification from the printer 200 within the first time limit following the start of the waiting process in S40 (S55: YES), the advertisement provision server 100 ultimately rescinds the winning bids in S120 and transmits a print cancellation instruction to the printer 200 in S60. According to the above embodiment, by automatically rescinding the winning bids and cancelling printing when costs associated with completing printing of the advertisements of the winning bidders cannot be charged within a certain period of time, the advertisement provision server 100 can protect the winning bidders.

Another feature of the above embodiment is the addition of a time limit on printing the advertisements of the winning bidders. A second time limit for completing printing is set in advance in S25. When the advertisement provision server 100 has not received a printing progress notification from the printer 200 within the second time limit following the start of the waiting process in S40 (S95: YES), the advertisement provision server 100 ultimately rescinds the winning bid in S120 and transmits a print cancellation instruction to the printer 200 in S97. According to the above embodiment, by automatically rescinding winning bids and cancelling printing when a printing progress notification has not been received within a certain period of time, the advertisement provision server 100 can attempt to protect the winning bidders. This method is particularly effective when advertisers have strict time requirements for advertisements such as fresh food products.

Another feature of the above embodiment is the addition of a time limit on printing the advertisements of the winning bidders. A third time limit for completing printing is set in advance in S25. When the printer 200 completes printing but the third time limit has already passed (S100: YES), the advertisement provision server 100 ultimately rescinds winning bids in S120. According to the above embodiment, by automatically rescinding winning bids and cancelling printing when printing of the advertisements of the winning bidders could not be completed within a certain period of time, the advertisement provision server 100 can protect the winning bidders. This method is particularly effective in cases where the value of an advertisement would drop significantly if not printed within the certain period of time.

Another feature of the above embodiment is that, when the printing progress notification received from the printer 200 indicates “printing incomplete” (S110: YES), the advertisement provision server 100 ultimately rescinds the winning bids in S120 and transmits a print cancellation instruction to the printer 200 in S115. According to the above embodiment, by automatically rescinding winning bids and instructing the printer 200 to cancel printing when the printer 200 cannot print advertisements of the winning bidders, the advertisement provision server 100 can protect these winning bidders.

Another feature of the above embodiment is that, when the user performs an operation to cancel printing on the terminal device 300, in S65 the terminal device 300 transmits a print cancellation instruction to the printer 200 (S70: YES), and in S90 the printer 200 transmits a printing progress notification to the advertisement provision server 100 indicating “printing failure”. In response, the advertisement provision server 100 rescinds the winning bids in S120. According to the above embodiment, by allowing the user to cancel printing as needed for advertisements already delivered to the printer 200, the winning bidders can be reliably protected.

Another feature of the above embodiment is that the advertisement provision server 100 adds information on winning bids that have been rescinded in S120 to a failure history in S130. Accordingly, a plurality of cases in which winning bids have been rescinded due to the above predetermined condition not being met can be aggregated to be processed altogether.

Another feature of the above embodiment is that a time limit can be added for printing the advertisements of the winning bidders. In S25 the advertisement provision server 100 sets a first time limit within which charging of delivery costs is to be performed for advertisements whose printing has been completed. The advertisement provision server 100 transmits a billing notice of delivery costs for the advertisements of the winning bidders in S140 only when printing has been completed properly within the first time limit. The method according to the above embodiment enables advertisers, i.e., the winning bidders to quickly learn when an advertisement has not been printed within the predetermined time limit, thereby facilitating budget management for the advertisers.

Another feature of the above embodiment is that, when the advertisement provision server 100 receives a printing progress notification indicating “printing successful” but only after the third time limit has passed since the waiting process has started in S40 (S100: YES), the advertisement provision server 100 does not transmit a billing notice for delivery costs in S140. The method according to the above embodiment ensures that advertisers are not billed for delivery costs when their advertisements have not been printed within the third time limit, thereby further facilitating budget management for the advertisers.

### VARIATIONS AND MODIFICATIONS

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### (1) When Cancellations of Printing Through User Operations are not Allowed

In the above embodiment, when the user performs an operation on the terminal device 300 to cancel printing in S65, the printer 200 determines in S70 that a print cancellation instruction has been received (S70: YES), and the advertisement provision server 100 can ultimately rescind the winning bid in S120. However, the present disclosure need not be limited to this method.

That is, the advertisement provision server 100 may be able to transmit an instruction to the printer 200 for controlling the printer 200 so that even when a print cancellation instruction to cancel printing is received from the user, such print cancellation instruction from the user will be considered unenforceable and the printer 200 will continue to print the advertisement. As an example of controlling the printer 200 in this way, the advertisement provision server 100 may add an instruction to the print instruction transmitted in S30 that invalidates the aforementioned print cancellation instruction by the user.

This modification ensures a smoother and more stable flow for the delivery and printing of the advertisement of the winning bidder by preventing users from recklessly cancelling the printing of the advertisement already delivered to the printer 200.

### (2) When the First Time Limit is Set Variable

As another modification, the control unit 110 of the advertisement provision server 100 acquires speed factor information related to the speed at which the printer 200 can process advertisements, such as printing speed based on the print settings and specifications of the printer 200, and the time required to download the advertisement images. Based on the acquired speed factor information, the control unit 110 performs a prediction process to estimate a print completion time which is the time at which printing of the advertisements of the winning bidders determined in S8 will be completed. In S25 the advertisement provision server 100 sets the first time limit based on the print completion time estimated in the prediction process. The prediction process is an example of the “(i) estimating” of the present disclosure.

In this modification, the control unit 110 dynamically sets a variable first time limit based on the time for completing printing estimated in the prediction process. Accordingly, the advertisement provision server 100 can set an appropriate first time limit that conforms to the printing performance of the printer 200 and attributes of the advertisements of the winning bidders, for example, thereby achieving a more effective process for the advertisers (i.e., the bidders). Note that the speed factor information described above may be stored in the storage unit 115 of the advertisement provision server 100 in advance, for example, and the advertisement provision server 100 may perform the prediction process on the basis of the stored speed factor information.

### (3) Other Modifications

As still another modification, rather than transmitting a print cancellation instruction to the printer 200 in S60, S97, and S115 as described above, the advertisement provision server 100 may re-transmit a print instruction of S30 to the printer 200 a predetermined number of times or for a predetermined period. Alternatively, the advertisement provision server 100 may repeatedly transmit a print instruction to the printer 200 until the advertisement provision server 100 receives a printing progress notification indicating “printing successful”.

In the above embodiment, the advertisement provision server 100 transmits a winning bid cancellation notice which serves as winning bid rescission information to the advertisement management server 500 in S120, without charging the advertisement management server 500 for costs in S140. However, the present disclosure is not limited to this method. That is, in a case where the above costs have been already charged and already settled by an external server, the advertisement provision server 100 may transmit a refund instruction instructing a refund of the costs to the advertisement management server 500 as the winning bid rescission information.

Alternatively, instead of the refund instruction described above, the advertisement provision server 100 may transmit a compensation instruction to the advertisement management server 500 as the winning bid rescinding information requesting the advertisement management server 500 to reduce other charges to be collected from the external server. Still alternatively, in a case where the above costs have been charged but payment has not yet been settled by the external server, the advertisement provision server 100 may transmit an instruction instructing to stop the payment to the advertisement management server 500 as the winning bid rescinding information. In these modifications, the process in which the advertisement provision server 100 transmits the instruction as the winning bid rescission information to the advertisement management server 500 is an example of the “(h) transmitting” of the present disclosure.

The above modifications describe cases in which the process for transmitting winning bid rescinding information is performed in real-time for every advertisement awarded a winning bid in S8 of FIG. 2, but the present disclosure is not limited to this method. That is, the advertisement provision server 100 may aggregate winning bid rescinding information within certain predetermined intervals and may transmit the aggregated winning bid rescinding information together once a month at the beginning of each month, for example.

Although the advertisement provision server 100 has been described above as a standalone device, a plurality of devices may operate in conjunction with each other to implement the functions of the advertisement provision server 100.

The flowcharts illustrated in FIGS. 2 and 3 in the above description do not limit the present disclosure to the steps indicated therein. Steps may be added or deleted, or their order may be rearranged, without departing from the spirit and technical ideas of the present disclosure.

In addition to what has already been described, the methods according to the embodiment and its modifications described above may be used in suitable combinations.

In addition, although not illustrated individually, the present disclosure may be implemented with various modifications without departing from the spirit of the present disclosure.

What is claimed is:

1. A delivery information provision server comprising a controller,
the controller being configured to perform:
(a) transmitting a bid solicitation request to a delivery information management server, the bid solicitation request requesting the delivery information management server to hold an auction in which bids are solicited for use of an information delivery service;
(b) receiving, from the delivery information management server, one or more pieces of delivery information corresponding to one or more bids placed in the auction held in response to the bid solicitation request, each of the one or more pieces of delivery information being information designated as a target of the information delivery service in association with placement of the corresponding bid;
(c) determining, after receiving the one or more pieces of delivery information, specific piece of delivery information from among the one or more pieces of delivery information received from the delivery information management server, the specific piece of delivery information corresponding to a winning bid among the one or more bids placed in the auction;
(d) transmitting, in response to determining the specific piece of delivery information, a delivery decision notice to the delivery information management server, the delivery decision notice being a notice of a decision to deliver the specific piece of delivery information to a printer as the information delivery service;
(e) transmitting the specific piece of delivery information to the printer;
(f) executing a waiting process to wait for progress information from the printer, the progress information indicating progress of printing of the specific piece of delivery information by the printer;
(g) determining whether or not results of the waiting process meet a predetermined condition, the predetermined condition corresponding to completion of the printing of the specific piece of delivery information; and
(h) transmitting, when determining that the results of the waiting process do not meet the predetermined condition, winning bid rescission information to the delivery information management server, the winning bid rescission information indicating that the winning bid has been rescinded.

2. The delivery information provision server according to claim 1,
wherein the controller is configured to further perform:
(i) transmitting, when determining that the results of the waiting process meet the predetermined condition, a billing notice to the delivery information management server, the billing notice being a notice for charging a cost for delivering the specific piece of delivery information.

3. The delivery information provision server according to claim 1,
wherein, when in the waiting process the controller does not receive the progress information within a first time limit, the controller determines that the results of the waiting process do not meet the predetermined condition, the first time limit being a predetermined time limit within which the cost for delivering the specific piece of delivery information is to be charged, and
wherein the controller is configured to further perform:
(j) transmitting, when determining that the results of the waiting process do not meet the predetermined condition, a print cancellation instruction to the printer in addition to transmitting the winning bid rescission information to the delivery information management server, the print cancellation instruction instructing the printer to cancel the printing of the specific piece of delivery information.

4. The delivery information provision server according to claim 1,
wherein, when the controller does not receive the progress information within a second time limit, the controller determines that the results of the waiting process do not meet the predetermined condition, the second time limit being a predetermined time limit within which the printing of the specific piece of delivery information is to be completed by the printer, and
wherein the controller is configured to further perform:
(k) transmitting, when determining that the results of the waiting process do not meet the predetermined condition, a print cancellation instruction to the printer in addition to transmitting the winning bid rescission information to the delivery information management server, the print cancellation instruction instructing the printer to cancel the printing of the specific piece of delivery information.

5. The delivery information provision server according to claim 1,
wherein, when the controller receives the progress information after a third time limit has passed, the controller determines that the results of the waiting process do not meet the predetermined condition, the third time limit being a predetermined time limit within which the printing of the specific piece of delivery information is to be completed by the printer.

6. The delivery information provision server according to claim 1,
wherein, when the controller receives the progress information indicating that the printing of the specific piece of delivery information has not been completed, the controller determines that the results of the waiting process do not meet the predetermined condition, and
wherein the controller is configured to further perform:
(l) transmitting, when determining that the results of the waiting process do not meet the predetermined condition, a print cancellation instruction to the printer in addition to transmitting the winning bid rescission information to the delivery information management server, the print cancellation instruction instructing the printer to cancel the printing of the specific piece of delivery information.

7. The delivery information provision server according to claim 1,
wherein, in the transmitting the specific piece of delivery information, the controller also transmits an instruction to the printer, the instruction instructing the printer to perform the printing of the specific piece of delivery information even when the printer receives a print cancellation instruction from a user, the print cancellation instruction instructing the printer to cancel the printing of the specific piece of delivery information.

8. The delivery information provision server according to claim 1,
wherein, when the controller receives the progress information indicating that the printing of the specific piece of delivery information has been cancelled by a user, the controller determines that the results of the waiting process do not meet the predetermined condition.

9. The delivery information provision server according to claim 1,
wherein the controller is configured to further perform:
(m) creating, when determining that the results of the waiting process do not meet the predetermined condition, history information indicating that the controller determines that the results of the waiting process do not meet the predetermined condition.

10. A delivery information provision server comprising a controller,
the controller being configured to perform:
(a) transmitting a bid solicitation request to a delivery information management server, the bid solicitation request requesting the delivery information management server to hold an auction in which bids are solicited for use of an information delivery service;
(b) receiving, from the delivery information management server, one or more pieces of delivery information corresponding to one or more bids placed in the auction held in response to the bid solicitation request, each of the one or more pieces of delivery information being information designated as a target of the information delivery service by the corresponding bid;
(c) determining, after receiving the one or more pieces of delivery information, specific piece of delivery information from among the one or more pieces of delivery information received from the delivery information management server, the specific piece of delivery information corresponding to a winning bid among the one or more bids placed in the auction;
(d) transmitting, in response to determining the specific piece of delivery information, a delivery decision notice to the delivery information management server, the delivery decision notice being a notice of a decision to deliver the specific piece of delivery information to a printer as the information delivery service;
(e) setting a time limit, the time limit being a predetermined time limit within which a cost for delivering the specific piece of delivery information is to be charged;
(f) transmitting the specific piece of delivery information to the printer;
(g) executing a waiting process to wait for progress information from the printer, the progress information indicating progress of printing of the specific piece of delivery information by the printer; and
(h) transmitting, when receiving, within the time limit in the waiting process, the progress information indicating that the printing of the specific piece of delivery information has been completed, a billing notice to the delivery information management server, the billing notice being a notice for charging the cost for delivering the specific piece of delivery information.

11. The delivery information provision server according to claim 10,
wherein, in the setting the time limit, the controller also sets another time limit, the another time limit being a predetermined time limit within which the printing of the specific piece of delivery information is to be completed by the printer, and
wherein, when receiving, after the another time limit has passed in the waiting process, the progress information indicating that the printing of the specific piece of delivery information has been completed, the controller does not transmit the billing notice to the delivery information management server.

12. The delivery information provision server according to claim 11,
wherein the controller is configured to further perform:
(i) estimating a print completion time on the basis of speed factor information, the print completion time being a time at which the printing of the specific piece of delivery information is completed, the speed factor information being information related to a speed at which the printer performs processing of the specific piece of delivery information, and
wherein the setting the time limit is performed on the basis of the print completion time estimated in the estimating.
